(19) United States
(12) Patent Application Publication
(10) Pub. No.: US 2025/0309655 A1
(43) Pub. Date: Oct. 2, 2025

(54) Management of a distributed energy storage, DES, arrangement

(71) Applicant: Elisa Oyj, Helsinki (FI)

(72) Inventors: Jukka-Pekka SALMENKAITA, Helsinki (FI); Esko HEINONEN, Helsinki (FI); Simon HOLMBACKA, Helsinki (FI)

(21) Appl. No.: 18/863,357

(22) PCT Filed: Jun. 1, 2023
(86) PCT No.: PCT/FI2023/050315

§ 371 Date: Nov. 6, 2024

(30) Foreign Application Priority Data
Jun. 27, 2022 (FI) 20225582

(51) Int. Cl. H02J 3/38; H02J 3/00

(52) U.S. Cl. CPC H02J 3/381; H02J 3/004

(57) ABSTRACT

A computer implemented method for managing a distributed energy storage, DES, arrangement, wherein the DES arrangement comprises a pool of nodes. The method is performed by monitoring (301) energy levels of battery systems of the nodes of the DES arrangement; identifying (302), based on monitoring the energy levels, one or more target nodes for optimization; and enabling (303) node specific up or down regulation actions for the target nodes irrespective of grid balancing actions of the whole DES arrangement.

### TECHNICAL FIELD

The present disclosure generally relates to management of distributed energy storage, DES, arrangements.

### BACKGROUND

This section illustrates useful background information without admission of any technique described herein representative of the state of the art.

A distributed energy storage (DES) arrangement is a pool of spatially distributed nodes controlled by a centralized control system. The nodes may be distributed over a vast geographical area. The nodes can be powered either by the electric grid or by a battery system connected to the node. The battery systems may be resources maintained for example for emergency energy backup purposes, such as backup batteries of a wireless communication network. Additionally or alternatively, the battery systems may be resources owned by households or small and medium sized companies or other smaller scale operators. A DES arrangement can be used for forming a virtual power plant (VPP) comprising a plurality of spatially distributed nodes. In this way a larger capacity may be built by pooling together smaller scale resources. As backup batteries are not constantly used, the battery systems of the nodes can be used for further optimization purposes e.g. through the VPP.

Such VPPs may participate in balancing of electric grid or in intraday trading market. Transmission system operators (TSO) offer reserve markets where reserve providers, such as VPP, can offer energy capacity for grid balancing purposes.

Now, there are provided some new considerations concerning management of distributed energy storage arrangements for the purpose of enabling participation in balancing of electric grid.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided a computer implemented method for managing a distributed energy storage, DES, arrangement, wherein the DES arrangement comprises a pool of nodes. The method comprises
monitoring energy levels of battery systems of the nodes of the DES arrangement;
identifying, based on monitoring the energy levels, one or more target nodes for optimization; and
enabling node specific up or down regulation actions for the target nodes irrespective of grid balancing actions of the whole DES arrangement.

In some embodiments, the target nodes are risk nodes that are at risk of being at least partially disabled from participating in grid balancing. A risk node may be disabled from participating in up regulation actions or in down regulation actions.

In some embodiments, the method further comprises activating node specific up or down regulation actions at least for one of the target nodes.

In some embodiments, the method further comprises enabling node specific up regulation actions at least for one of the target nodes, while the whole DES arrangement is performing down regulation actions, and/or enabling node specific down regulation actions at least for one of the target nodes, while the whole DES arrangement is performing up regulation actions.

In some embodiments, the method further comprises enabling the node specific up or down regulation actions so that overall effect of those on grid balancing of the whole DES arrangement is zero during periods of no regulation actions by the whole DES arrangement.

In some embodiments, said identifying is further based on grid balancing commitments and/or predefined operating objectives of the whole DES arrangement.

In some embodiments, said identifying is further based on at least one of the following: predicted grid balancing activation needs, energy levels of other battery systems of the DES arrangement, predefined energy balancing plans, predefined minimum/maximum energy levels, predefined minimum/maximum power levels, availability of different energy sources.

In some embodiments, the method further comprises identifying a node as a target node, if the battery system of the node is close to a minimum energy level, when up regulation need is expected; and/or identifying a node as a target node, if the battery system of the node is close to a maximum energy level, when down regulation need is expected.

In some embodiments, the method further comprises adjusting grid balancing actions of the whole DES arrangement to compensate the node specific up or down regulation actions.

In some embodiments, the method further comprises forecasting, whether the whole DES arrangement is at risk of being unable to fulfil grid balancing commitments disabled from participating in grid balancing due to operation of the identified target nodes; and performing the enabling step responsive to forecasting that the whole DES arrangement is at risk of being unable to fulfil grid balancing commitments. disabled from participating in grid balancing.

In some embodiments, the forecasting is based on assuming continuous regulation needs, based on simulation of regulation needs and/or based on observed historical regulation needs.

In some embodiments, the method further comprises
detecting that the battery systems of plurality of nodes are close to a maximum energy level; and responsively discharging the battery systems of the plurality of nodes by local consumption to set a new base energy level for the plurality of nodes; and/or
detecting that the battery systems of plurality of nodes are close to a minimum energy level; and responsively charging the battery systems of the plurality of nodes to set a new base energy level for the plurality of nodes.

According to a second example aspect of the present invention, there is provided an apparatus comprising means for performing the method of the first aspect or any related embodiment. The means may comprise a processor and a memory including computer program code, and wherein the memory and the computer program code are configured to, with the processor, cause the performance of the apparatus.

According to a third example aspect of the present invention, there is provided a computer program comprising computer executable program code which when executed by a processor causes an apparatus to perform the method of the first aspect or any related embodiment.

According to a fourth example aspect there is provided a computer program product comprising a non-transitory computer readable medium having the computer program of the third example aspect stored thereon.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a system according to an example embodiment;

FIG. 2 shows a block diagram of an apparatus according to an example embodiment; and

FIGS. 3-4 show flow charts according to example embodiments.

### DETAILED DESCRIPTION

In the following description, like reference signs denote like elements or steps.

Various embodiments of present disclosure provide mechanisms to manage a distributed energy storage, DES, arrangement, wherein the DES arrangement comprises a pool of nodes. The nodes are spatially distributed entities that can be powered either by the electric grid or by a battery system connected to the node. The battery systems may be resources maintained for example for emergency energy backup purposes, such as backup batteries of a wireless communication network. Additionally or alternatively, the battery systems may be resources owned by households or small and medium sized companies or other smaller scale operators. As an alternative non-limiting example, the battery systems may be intended for storing energy from renewable sources such as solar panels and/or wind generators or even from a fuel-operated genset. As yet another alternative or additional non-limiting example, the intended use of the battery systems is optimization of self-consumption. The node may be a hybrid system using multiple energy sources.

In general, the battery systems in this disclosure refer to battery systems that are able to handle regular charge and discharge cycles. For example, lithium-ion batteries are such battery systems. In more detail, one or more of the following battery technologies may be represented in the pool of DES nodes: lithium-nickel-cobalt, NCA, lithium-iron-phosphate, LFP, lithium-nickel-manganese-cobalt, NMC, flow batteries, and solid-state batteries. The battery systems may have different properties with regard to price, durability, physical size and wear depending for example on the battery technology and storage capacity.

In general, lithium-ion batteries should not regularly exceed extreme low or high charge values. For example, state of charge below 5% or above 95% should be avoided. Such limitations should be taken into account in usage of the lithium-ion batteries to avoid increased wear of the batteries.

A DES arrangement can be used for forming a virtual power plant (VPP) comprising a plurality of spatially distributed nodes. In this way a larger capacity may be built by pooling together smaller scale resources. As backup batteries are not constantly used, the battery systems of the nodes can be used for further optimization purposes e.g. through the VPP.

Such VPPs may participate in balancing of electric grid or in intraday trading market. Transmission system operators (TSO) offer reserve markets where reserve providers, such as VPPs, can offer energy capacity for grid balancing purposes.

Frequency balancing of electric grid may be arranged for example using automatic Frequency Restoration Reserve, aFRR, or Frequency Containment Reserve, FCR, capacity market. aFRR is a centralized automatically activated reserve. Its activation is based on a power change signal calculated on the base of the frequency deviation in the Nordic synchronized area. Its purpose is to return the frequency to the nominal value. FCR is an active power reserve that is automatically controlled based on the frequency deviation. FCR may be Frequency Containment Reserve for Normal Operation, FCR-N, or Frequency Containment Reserve for Disturbances, FCR-D. Their purpose is to contain the frequency during normal operation and disturbances.

The frequency balancing may comprise up regulation and/or down regulation. Up regulation means increasing power production or decreasing consumption. Down regulation means decreasing power production or increasing consumption.

In order to participate in the grid balancing, the DES nodes need to be activated upon detecting a balancing need (which may be referred to as a regulation need). The balancing need may be automatically detected, or the balancing need may be signalled in a balancing request. The balancing need may relate to up regulation or down regulation.

Various embodiments of present disclosure provide a centralized coordinator for managing a DES arrangement so that the DES arrangement can be used for participating in frequency balancing of electric grid e.g. in the aFRR and/or FCR capacity market.

Properties of the nodes of a DES arrangement may be heterogenous. That is, energy capacity and/or power characteristics of the nodes may vary. E.g. maximum charging and discharging power of the nodes may vary, local energy consumption of the nodes may vary, the nodes may have adjustable or non-adjustable local power consumption, and/or the nodes may have possibility for local power generation (e.g. renewable energy sources such as solar panels or windmills may be available). Further, rectifier properties and/or power profiles of different nodes may vary.

Normally, having distributed assets of a DES arrangement performing both up and down regulation actions simultaneously would not be desirable for example due to unnecessary energy round-trip losses, possible additional costs from energy transmission fees, and additional wear of batteries. For this reason, the DES arrangements are usually controlled to stop all up regulation activities before starting any down regulation, and vice versa.

Due to heterogenous properties of the nodes, energy levels of battery systems may be near minimum at some nodes while the energy levels at some other nodes may be near maximum. For this reason, the capability of different individual nodes in participating in up or down regulation actions may vary and some nodes may be disabled from participating in grid balancing either in up or down direction. If some of the nodes are disabled, even the whole DES arrangement pooling the capacity of the individual nodes may be at risk of not being able to fulfil the balancing commitment made in the grid balancing market. In this way, the DES arrangement may be at least partially disabled from participating in grid balancing due to capabilities of individual nodes.

One aim of present disclosure is to achieve efficient use of nodes of a DES arrangement for balancing of electric grid. This is provided by controllably enabling node specific up and down regulation actions for certain target nodes. In some embodiments, the up and down regulations may be simultaneously enabled in the DES arrangement in a controlled manner.

The target nodes may be for example nodes that are identified as being at risk of being disabled from either up or down regulation actions. In this way, various embodiments may provide reducing the risk of having disabled nodes. Consequently, grid balancing may be improved whereby more stable energy source may be achieved without additional environmental burden.

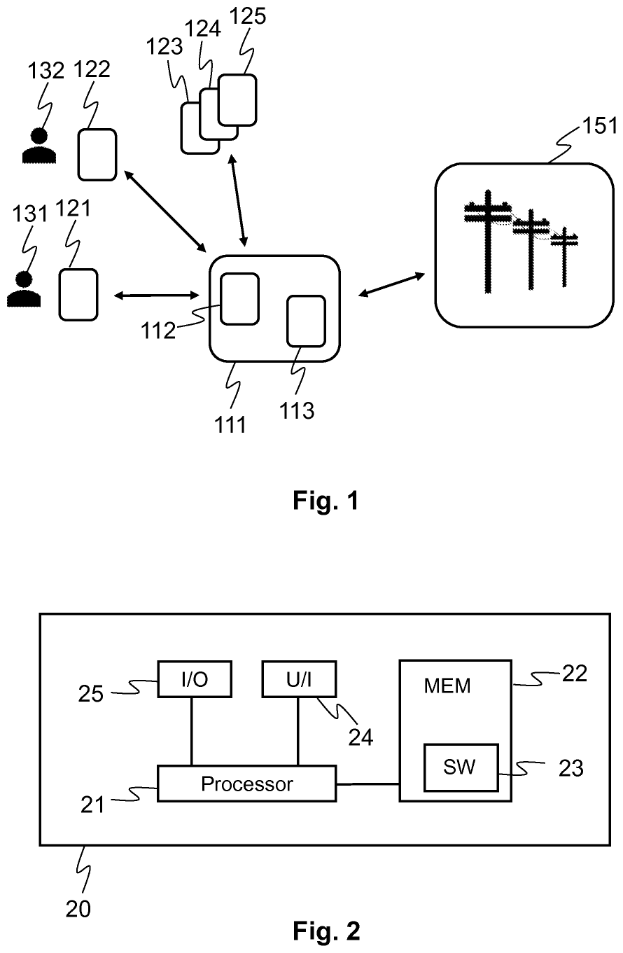

FIG. 1 schematically shows an example scenario according to an embodiment. The scenario shows a DES arrangement formed of a pool of nodes 121-125. The nodes 121-125 may be located at different geographical locations, but equally there may be plurality of nodes at the same location. FIG. 1 shows the nodes 123-125 at the same location and the nodes 121 and 122 individually at different locations. The nodes 121 and 122 are owned by individuals 131 and 132, respectively. The nodes 123-125 are co-located nodes owned for example by a small company. It is to be noted that this is only a non-limiting illustrative example and in practical implementations many different setups are possible.

Further, the scenario shows a coordinator system 111. Still further, FIG. 1 shows an electric grid 151.

The coordinator system 111 is configured to implement at least some example embodiments of present disclosure to manage the nodes 121-125 of the DES arrangement. For this purpose, the coordinator system 111 is operable to interact with the nodes 121-125 or equipment associated thereto. The coordinator system 111 comprises a first interface 112 for such interaction. Communication over the first interface 112 is implemented for example using Simple Network Management Protocol (SNMP). Additionally, the coordinator system 111 is operable to interact with the electric grid 151 or equipment associated thereto to coordinate participation in frequency balancing of the electric grid. The coordinator system 111 comprises a second interface 113 for this purpose.

The coordinator system 111 may receive compensation based on the frequency balancing carried out for the electric grid. The compensation may depend on actual activation of frequency balancing and/or on reserving capacity for the possible frequency balancing needs. Further, there may be penalty, if the DES arrangement fails to fulfil the frequency balancing commitments. Therefore, there is an incentive to fulfil the commitments made.

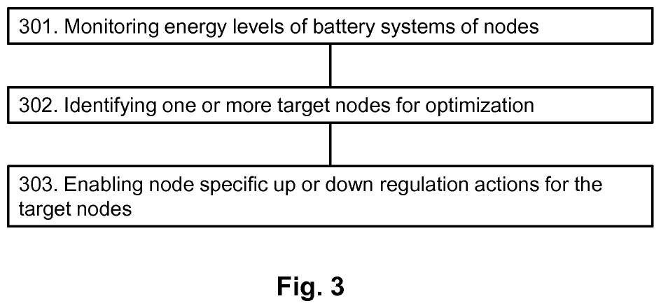

FIG. 2 shows a block diagram of an apparatus 20 according to an embodiment. The apparatus 20 is for example a general purpose computer, cloud computing environment or some other electronic data processing apparatus. The apparatus 20 can be used for implementing at least some embodiments of present disclosure. That is, with suitable configuration the apparatus 20 is suited for operating for example as the coordinator system 111 of FIG. 1.

The apparatus 20 comprises a communication interface 25; a processor 21; a user interface 24; and a memory 22. The apparatus 20 further comprises software 23 stored in the memory 22 and operable to be loaded into and executed in the processor 21. The software 23 may comprise one or more software modules and can be in the form of a computer program product.

The processor 21 may comprise a central processing unit (CPU), a microprocessor, a digital signal processor (DSP), a graphics processing unit, or the like. FIG. 2 shows one processor 21, but the apparatus 20 may comprise a plurality of processors.

The user interface 24 is configured for providing interaction with a user of the apparatus. Additionally or alternatively, the user interaction may be implemented through the communication interface 25. The user interface 24 may comprise a circuitry for receiving input from a user of the apparatus 20, e.g., via a keyboard, graphical user interface shown on the display of the apparatus 20, speech recognition circuitry, or an accessory device, such as a headset, and for providing output to the user via, e.g., a graphical user interface or a loudspeaker.

The memory 22 may comprise for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 20 may comprise a plurality of memories. The memory 22 may serve the sole purpose of storing data, or be constructed as a part of an apparatus 20 serving other purposes, such as processing data.

The communication interface 25 may comprise communication modules that implement data transmission to and from the apparatus 20. The communication modules may comprise a wireless or a wired interface module(s) or both. The wireless interface may comprise such as a WLAN, Bluetooth, infrared (IR), radio frequency identification (RF ID), GSM/GPRS, CDMA, WCDMA, LTE (Long Term Evolution) or 5G radio module. The wired interface may comprise such as Ethernet or universal serial bus (USB), for example. The communication interface 25 may support one or more different communication technologies. The apparatus 20 may additionally or alternatively comprise more than one of the communication interfaces 25.

A skilled person appreciates that in addition to the elements shown in FIG. 2, the apparatus 20 may comprise other elements, such as displays, as well as additional circuitry such as memory chips, application-specific integrated circuits (ASIC), other processing circuitry for specific purposes and the like.

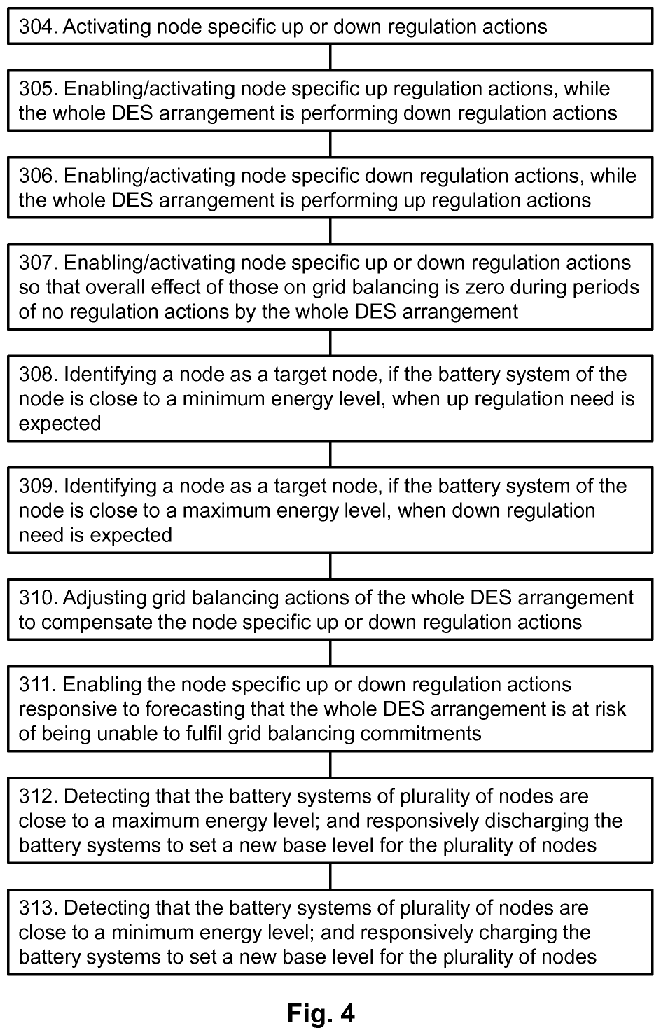

FIGS. 3 and 4 show flow charts according to example embodiments. FIGS. 3 and 4 illustrate processes comprising various possible steps including some optional steps while also further steps can be included and/or some of the steps can be performed more than once. The processes may be implemented in the coordinator system 111 of FIG. 1 and/or in the apparatus 20 of FIG. 2. The processes are implemented in a computer program code and does not require human interaction unless otherwise expressly stated. It is to be noted that the processes may however provide output that may be further processed by humans and/or the processes may require user input to start.

The process of FIG. 3 comprises the following steps:

301: Energy levels of battery systems of nodes of a DES arrangement are monitored.

In practice, the energy levels are obtained or read from a suitable source. The energy levels may be obtained or read directly from the battery systems or the respective nodes or through some intermediary system.

302: The monitored energy levels are used for identifying one or more target nodes for optimization. The optimization is performed in the following step 303.

303: Node specific up or down regulation actions is enabled for the target nodes irrespective of grid balancing actions of the whole DES arrangement. That is, optimization of the target nodes is performed by enabling node specific up or down regulation actions for the target nodes. In addition to enabling the node specific up or down regulation actions, the node specific up or down regulation actions may be activated in one or more of the target nodes. For the sake of clarity, it is noted that it is not mandatory to perform the activation at the same time with enabling the node specific actions. Further, it is not mandatory to activate the node specific actions in all target nodes.

The target nodes may be risk nodes that are at risk of being at least partially disabled from participating in grid balancing actions. The risk nodes may be at risk of not being able to participate in grid balancing actions in up direction or at risk of not being able to participate in grid balancing actions in down direction. Additionally or alternatively, the target nodes may be nodes that would benefit from being able to charge or discharge in an individually controlled manner.

The node specific up or down regulation actions refer to discharging or charging of battery systems of nodes based on conditions (e.g. state of charge, predicted local consumption etc.) of the individual battery systems. The node specific up or down regulation actions may be opposite to regulation actions performed by or required from the whole DES arrangement.

The target nodes may be identified solely based on the energy levels of the battery systems. Additionally or alternatively, the identification of the target nodes may take into account grid balancing commitments of the whole DES arrangement, predefined operating objectives of the DES arrangement, predicted grid balancing activation needs, energy levels of other battery systems of the DES arrangement, predefined energy balancing plans, predefined minimum and/or maximum energy and/or power levels, availability of different (possibly local) energy sources (e.g. renewable energy sources such as solar panels or windmills). It is to be noted that operation of the DES arrangement is not deterministic, and plurality of different factors may need to be taken into account in identifying of the target nodes. The grid balancing commitments of the whole DES arrangement may for example define availability of certain amount of up and/or down regulation resources for certain time period. The predefined operating objectives of the DES arrangement may for example include certain targets for energy levels and/or power levels in the DES arrangement. Additionally or alternatively, the predefined operating objectives of the DES arrangement may define acceptable failure margin in fulfilling the grid balancing commitments of the whole DES arrangement.

The process of FIG. 4 comprises the following steps. One or more of the steps of FIG. 4 may be implemented in the process of FIG. 3. Clearly all steps of FIG. 4 are not mandatory.

304: Node specific up or down regulation actions are activated for at least one of the target nodes. The activation may be performed based on state of charge of the target node and/or based on other conditions of the target node. Additionally, information relating to the whole DES arrangement may be taken into account in the activation.

305: Node specific up regulation actions are enabled and/or activated at least for one of the target nodes, while the whole DES arrangement is performing down regulation actions.

306: Node specific down regulation actions are enabled and/or activated at least for one of the target nodes, while the whole DES arrangement is performing up regulation actions.

307: The node specific up or down regulation actions are enabled and/or activated so that overall effect of those on grid balancing is zero during periods of no regulation actions by the whole DES arrangement. That is, if up regulation is enabled and/or activated for one node, corresponding down regulation is provided elsewhere in the DES arrangement. The same way, if down regulation is enabled and/or activated for one node, corresponding up regulation is provided elsewhere in the DES arrangement.

In an embodiment, the node specific up or down regulation actions may be used for providing desired grid balancing effect by stopping the node specific up regulation actions when a down regulation need is detected to provide a down regulation effect and/or stopping the node specific down regulation actions when an up regulation need is detected to provide an up regulation effect.

308: A node is identified as a risk node, if the battery system of the node is close to a minimum energy level, when up regulation need is expected.

309: A node is identified as a risk node, if the battery system of the node is close to a maximum energy level, when down regulation need is expected.

Expected up and down regulation needs may be based on agreed or predicted regulation periods or based on observed historical regulation needs.

310: Grid balancing actions of the whole DES arrangement are adjusted to compensate the node specific up or down regulation actions. This may cause a need for additional up or down regulation in some parts of the DES arrangement.

311: The node specific up or down regulation actions are enabled and/or activated responsive to forecasting that the whole DES arrangement is at risk of being unable to fulfil grid balancing commitments. It is to be noted that in such case the whole DES arrangement may be able to participate in grid balancing to some extent, but completely fulfilling the commitments made may be impossible or at least challenging. In an extreme case the whole DES arrangement may be partially or fully disabled from participating in grid balancing.

The forecasting may be based on assuming continuous regulation needs, based on simulation of regulation needs, and or based on observed historical regulation needs.

In some situations, capabilities of the nodes of the DES arrangement may be substantially homogeneous which may prevent some types of regulation actions. For example, all or a majority of the nodes may be close to a maximum energy level, whereby they are not able to charge much energy, or all or a majority of the nodes may be close to a minimum energy level, whereby they are not able to output much energy. In such situations enabling node specific opposite actions might not be beneficial. In an embodiment such situation is checked for prior to enabling the node specific up or down regulation actions in step 303 of FIG. 3. In such situation, the enabling step may be prevented or postponed or the number of target nodes may be limited or the amount of energy that may be used in node specific actions may be limited.

In steps 312 and 313, base energy level of the battery systems of the nodes is adjusted if a plurality of nodes or a majority of nodes are close to a maximum or minimum energy level. In this way, regulation actions in both directions are enabled even with substantially homogenous nodes. The steps 312 and 313 are preferably performed during no regulation by the whole DES arrangement.

In some embodiments, there may be relatively short rest periods that are reserved for performing adjustment of the base energy level or the like actions. Such rest periods are not used for performing grid balancing actions.

312: It is detected that the battery systems of a plurality of nodes are close to a maximum energy level, and responsively the battery systems of the plurality of nodes are discharged to set a new base energy level for the plurality of nodes. In this way, one achieves room for down regulation actions by the whole DES arrangement. The discharging may be performed by using battery resources in local consumption.

In an embodiment, the new base energy level is set by computing total energy level reduction that can be performed in the whole DES arrangement so that up regulation actions are still possible and by evenly spreading the total energy level reduction to the plurality of nodes.

313: It is detected that the battery systems of a plurality of nodes are close to a minimum energy level, and responsively the battery systems of the plurality of nodes are charged to set a new base energy level for the plurality of nodes. In this way, one achieves capacity for up regulation actions by the whole DES arrangement. The energy for the charging may be taken from the grid or from local energy sources.

In an embodiment, the new base energy level is set by computing total energy level increase that can be performed in the whole DES arrangement so that down regulation actions are still possible and by evenly spreading the total energy level increase to the plurality of nodes.

The new base energy levels defined in steps 312 and 313 may then be used as a starting point in future management operations.

In an example case, a node is using 10 kW power and battery system of the node is close to a maximum. In order to set a ned base energy level, the system starts taking 1 kW from the battery system and uses 9 kW from grid (the new base level). If the node needs to participate to up regulation activation with 5 kW, the system takes in total 6 kW from the battery system and 4 kW from the grid. If the node needs to participate to down regulation activation with 5 kW, the system starts charging the battery system with 4 kW so that total power consumption from the grid is 14 kW.

The plurality of nodes in steps 312 and 313 may refer to majority of nodes of the DES arrangement or even to all nodes of the DES arrangement.

The maximum and minimum energy levels may refer to some predefined recommended maximum and minimum instead of completely full and totally empty. The maximum may be for example 85% of the total capacity and the minimum may be for example 30% of the total capacity. The minimum may be affected by fixed requirement of certain backup energy.

Without in any way limiting the scope, interpretation, or application of the appended claims, a technical effect of one or more of the example embodiments disclosed herein is improved management of a DES arrangement or a virtual power plant, VPP. For example, risks of being unable to fulfil grid balancing commitments or otherwise set targets may be alleviated by enabling node specific up and/or down regulation actions in a controlled manner. In this way, one achieves a hybrid of centralized control of the DES arrangement and individual control of nodes of the DES arrangement. Consequently, ability to efficiently use DES arrangement may be improved. Efficient usage of already existing energy resources may provide environmental benefits.

It is to be noted that novelty of present embodiments may be partially based on identification of the problems arising from heterogenous nodes of a VPP. In large power generation units, such as hydro power plants, the whole unit is straightforwardly controlled to provide either up regulation, down regulation or not participating in regulation at all. As the purpose of VPPs is in general to mimic operation of large power generation units, a straightforward solution is to control the VPP as one big unit the same way as large power generation units. The need for fine tuning the operation of individual nodes of a VPP may not be straightforwardly identified by a skilled person. The inventors of present embodiments have however identified that requirements in managing VPPs are different from managing large power generation units and have invented embodiments that are particularly suited for managing DES arrangement or a virtual power plant, VPP, formed of a plurality of smaller scale nodes with heterogenous properties and thereby possibly diverging capabilities to participate in regulation actions.

Any of the afore described methods, method steps, or combinations thereof, may be controlled or performed using hardware; software; firmware; or any combination thereof. The software and/or hardware may be local; distributed; centralised; virtualised; or any combination thereof. Moreover, any form of computing, including computational intelligence, may be used for controlling or performing any of the afore described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A computer implemented method for managing a distributed energy storage (DES) arrangement to participate in grid balancing, wherein the DES arrangement comprises a pool of nodes; the method comprising:
monitoring energy levels of battery systems of the nodes of the DES arrangement;
identifying, based on monitoring the energy levels, one or more target nodes for optimization; and
enabling node specific up or down regulation actions for the target nodes irrespective of grid balancing actions of the whole DES arrangement, wherein the node specific up regulation action comprises discharging battery systems of the nodes and node specific down regulation action comprises charging battery systems of the nodes based on conditions of the individual battery systems.

2. The method of claim 1, wherein the target nodes are risk nodes that are at risk of being at least partially disabled from participating in grid balancing.

3. The method of claim 1, further comprising activating node specific up or down regulation actions at least for one of the target nodes.

4. The method of claim 1, further comprising enabling node specific up regulation actions at least for one of the target nodes, while the whole DES arrangement is performing down regulation actions.

5. The method of claim 1, further comprising enabling node specific down regulation actions at least for one of the target nodes, while the whole DES arrangement is performing up regulation actions.

6. The method of claim 1, further comprising enabling the node specific up or down regulation actions so that overall effect of those on grid balancing of the whole DES arrangement is zero during periods of no regulation actions by the whole DES arrangement.

7. The method of claim 1, wherein said identifying is further based on grid balancing commitments and/or predefined operating objectives of the whole DES arrangement.

8. The method of claim 1, wherein said identifying is further based on at least one of the following: predicted grid balancing activation needs, energy levels of other battery systems of the DES arrangement, predefined energy balancing plans, predefined minimum/maximum energy levels, predefined minimum/maximum power levels, availability of different energy sources.

9. The method of claim 1, further comprising identifying a node as a target node, if the battery system of the node is close to a minimum energy level, when up regulation need is expected; and/or identifying a node as a target node, if the battery system of the node is close to a maximum energy level, when down regulation need is expected.

10. The method of claim 1, further comprising adjusting grid balancing actions of the whole DES arrangement to compensate the node specific up or down regulation actions.

11. The method of claim 1, further comprising forecasting, whether the whole DES arrangement is at risk of being unable to fulfil grid balancing commitments due to operation of the identified target nodes; and performing (311) the enabling step responsive to forecasting that the whole DES arrangement is at risk of being unable to fulfil grid balancing commitments.

12. The method of claim 1, wherein the forecasting is based on assuming continuous regulation needs, based on simulation of regulation needs and/or based on observed historical regulation needs.

13. The method of claim 1, further comprising:
detecting that the battery systems of a plurality of nodes are close to a maximum energy level; and responsively discharging the battery systems of the plurality of nodes by local consumption to set a new base energy level for the plurality of nodes; and/or
detecting that the battery systems of a plurality of nodes are close to a minimum energy level; and responsively charging the battery systems of the plurality of nodes to set a new base energy level for the plurality of nodes.

14. (canceled)

15. An apparatus comprising a processor and a memory including computer program code, and wherein the memory and the computer program code are configured to, with the processor, cause the performance of the method of claim 1.

16. A non-transitory computer readable medium having the computer program comprising computer executable program code which when executed in an apparatus causes the apparatus to perform the method of claim 1.
